(19) United States
(12) Patent Application Publication
(10) Pub. No.: US 2009/0106501 A1
(43) Pub. Date: Apr. 23, 2009

(54) Data cache management mechanism for packet forwarding

(75) Inventors: Xi Wang, Irvine, CA (US); Leo Kaplan, Laguna Hills, CA (US)

Correspondence Address: FARJAMI & FARJAMI LLP, 26522 LA ALAMEDA AVENUE, SUITE 360, MISSION VIEJO, CA, 92691, US

(73) Assignee: BROADCOM CORPORATION, Irvine, CA (US)

(21) Appl. No.: 11/975,271

(22) Filed: Oct. 17, 2007

(51) Int. Cl. G06F 12/00

(52) U.S. Cl. 711/143; 711/E12.001

(57) ABSTRACT

There is provided a method of managing a cache memory. The method comprising resetting a flag indicative of lack of incoming data for generating a packet for forwarding; receiving the incoming data; storing the incoming data in the main memory; transferring the incoming data from the main memory into a cache buffer within the cache memory, the cache buffer having a buffer size; setting the flag indicative of the incoming data received for generating the packet for forwarding; processing the incoming data to generate the packet in the cache buffer for forwarding, the packet having a packet size; writing back the packet from the cache buffer into the main memory; first invalidating a portion of the cache buffer; transmitting the packet after the first invalidating; and second invalidating, after the transmitting, the cache buffer for the buffer size if the flag is not set by the setting.

### BACKGROUND OF THE INVENTION

1. Field of the Invention

The present invention relates generally to memory management in a computer system. More particularly, the present invention relates to data cache management mechanisms.

2. Background Art

Computer networks, such as the Internet, Intranet and the like, utilize various communication devices for exchanging packets of data between the computers and other devices within the network. Packet forwarding engines are common components of many such communication devices, as in routers, switches, firewalls, etc. In a microprocessor-based system, a generic abstraction of software packet forwarding may be described as the microprocessor reading packets from an input interface, performing packet processing and outputting processed packets through an output interface.

Packet throughput is an important factor for the overall performance of communication devices, and the packet processing time needs to be minimized to achieve better performance. As high density DRAM (dynamic random access memory) is much slower than the microprocessor and logic devices, and cache memory is frequently utilized to hold frequently used data to speed up memory access. Cache memory is random access memory (RAM) that the microprocessor can access more quickly than it can access the high density DRAM. As the microprocessor processes data, it looks first in the cache memory and if it finds the data there (from a previous reading of data), the microprocessor does not have to do the more time-consuming reading of data from larger memory or the high density DRAM. Cache memory, therefore, helps expedite data access for the microprocessor, which otherwise would need to fetch from the larger memory.

Typically, a cache is made up of a pool of entries. Each entry has a datum (a nugget of data) which is a copy of the datum in the main memory. Each entry also has a tag, which specifies the identity of the datum in the main memory of which the entry is a copy. When the microprocessor wishes to access a datum presumably in the main memory, it first checks the cache. If an entry can be found with a tag matching that of the desired datum, the datum in the entry is used instead. When a datum is written to the cache, it must at some point be written to the main memory as well. The timing of this write is controlled by what is known as the write policy. In a write-back cache, writes are not immediately mirrored to the store. Instead, the cache tracks which of its locations have been written over (these locations are marked dirty). The data in these locations are written back to the main memory when those data are evicted from the cache. Data write-back may be triggered by other policies as well. The microprocessor may make many changes to a datum in the cache, and then explicitly notify the cache to write back the datum to the main memory.

Managing the cache is a necessary part of any cache-based system, so that data are not lost or overwritten. For example, if the microprocessor updates data in a cache, and the data are not yet transferred to the main memory, another device reading from the main memory will receive outdated data. Cache coherency is achieved by well-designed cache management algorithms that keep track of the cache. It is even more critical in symmetric multiprocessing where the main memory can be accessed by other devices.

It is known that the cache management algorithms, utilized for maintaining cache coherency, have a considerable impact on the performance of communication device. There is still an intense need in the art for efficient data cache management algorithms for use in the communication devices for packet forwarding, which need is addressed by the present application.

### SUMMARY OF THE INVENTION

There is provided methods and systems for data cache management, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a conventional communication device utilizing a cache;

FIG. 2 illustrates a conventional process flow diagram for managing the cache of FIG. 1 to maintain cache coherency;

FIG. 3 illustrates a data flow diagram for managing the cache of FIG. 1 to maintain cache coherency, according to one embodiment of the present invention; and

FIG. 4 illustrates a process flow diagram for managing the cache of FIG. 1, and corresponding to FIG. 3, according to one embodiment of the present invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

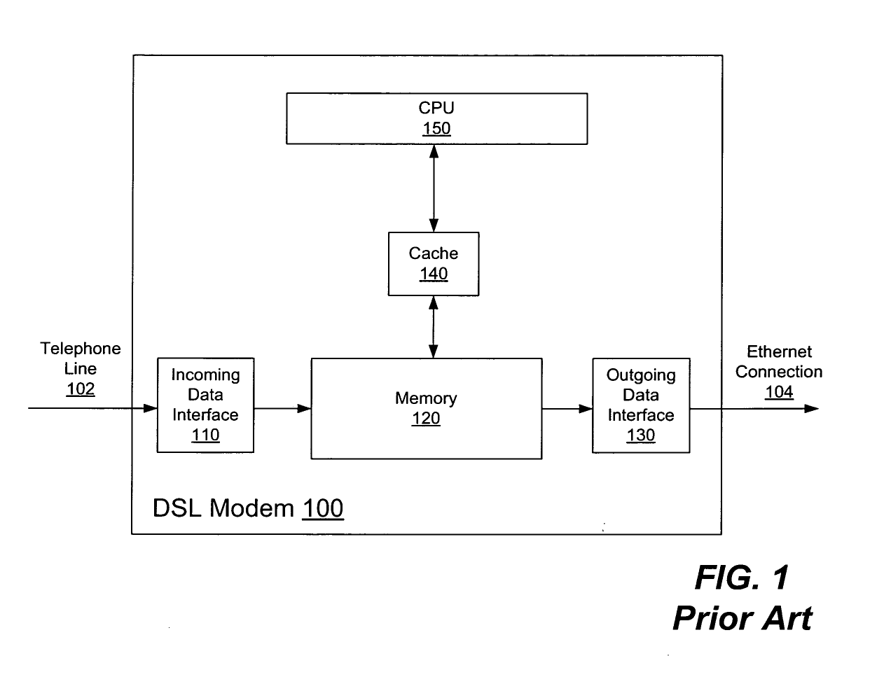

FIG. 1 illustrates a conventional communication device, such as DSL (digital subscriber line) modem 100 utilizing cache 140 to expedite data processing by central processing unit (CPU) or logic device 150. As shown in FIG. 1, DSL modem 100 is connected to telephone line 102 at one end and Ethernet connection 104 at the other end. In one aspect of its operation, as known in the art, DSL modem 100 receives incoming data over telephone line 102, CPU 150 processes the incoming data to generate outgoing data, and the outgoing data are transmitted over Ethernet connection 104. Although not shown, DSL modem 100 also receives data over Ethernet connection 104, which data is also processed and transmitted at the other end over telephone line 102. It should be noted that DSL modem 100 is merely an example of a communication device, and the present invention is not limited for use in DSL modems.

As shown in FIG. 1, DSL modem 100 includes incoming data interface 110 for receiving the incoming data over telephone line 102, memory 120 in communication with incoming data interface 110 for storing the incoming data, the processed data and the outgoing data. DSL modem 100 also includes cache 140 interposed between memory 120 and CPU 150, and outgoing data interface 130 in communication with memory 120 for transmitting the outgoing data over Ethernet connection 104.

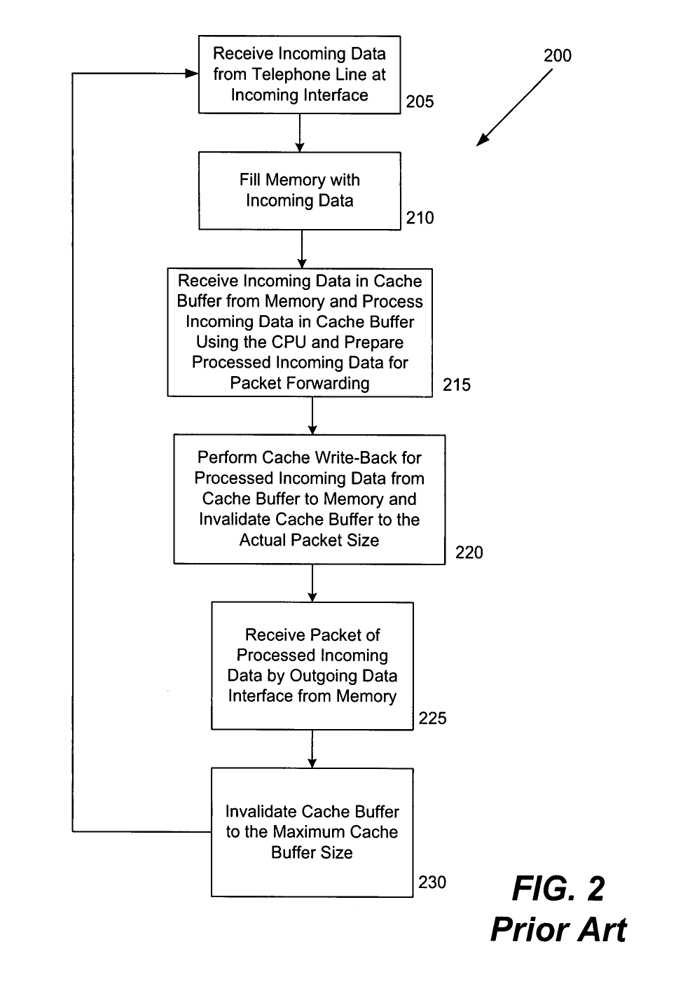

FIG. 2 illustrates conventional process flow diagram 200 for managing cache 140 of FIG. 1 to maintain cache coherency. As shown in FIG. 2, flow diagram 200 starts at step 205, where incoming data interface 110 receives incoming data over telephone line 102. Next, at step 210, memory 120 receives the incoming data from incoming data interface 110 and is filled with the incoming data. At step 215, the incoming data from memory 120 is transferred into a cache buffer in cache 140, and CPU 150 applies a number of layers of processing to the incoming data in the cache buffer of cache 140 for packetization and to generate processed incoming data or data packets for forwarding over Ethernet connection 104. As used in the present application, a cache buffer is a set of cache entries (cache lines) mapped to a memory block in memory 120, and the memory block functions as a buffer.

Next, at step 220, CPU 150 performs a cache write-back to write the processed incoming data from the cache buffer of cache 140 into memory 120. Further, in order to ensure cache coherency, CPU 150 invalidates the cache buffer of cache 140 to the actual packet size, e.g. an actual packet size from 60 bytes to 1,514 bytes. In other words, to invalidate a cache buffer, a range of addresses belonging to the cache buffer is invalidated.

Continuing with flow diagram 200, at step 225, outgoing data interface 130 receives the processed incoming data, i.e. the data packet generated by CPU 150 and transferred from cache 140 to memory 120, and outgoing data interface 130 forwards the packet over Ethernet connection 104. Next, at step 230, in order to ensure cache coherency, CPU 150 invalidates the cache buffer in cache 140 to the maximum cache buffer size, e.g. 1,514 bytes. Next, process flow diagram 200 returns to step 205 for processing additional incoming data.

The conventional approach of process flow diagram 200, however, is quite inefficient. More specifically, although the data packet size may differ from one to the next, at step 230, the cache buffer of cache 140 is invalidated for the cache buffer size, e.g. 1,514 bytes. However, a packet may only be 60 bytes long. In such event, valuable processing time is wasted for invalidating additional 1,454 bytes in the cache buffer of cache 140. Even more, at step 220, only some bytes may have been modified in the cache buffer of cache 140, however, in order to ensure cache coherency, the entire packet length in cache buffer of cache 140 is invalidated.

Communication devices are stressed the most when passing small packets, because packet processing time is not highly correlated to packet size but determined by the number of packets. For example, for Ethernet transactions, excluding the CRC, the smallest packet is 60 bytes long and the largest packet is 1,514 bytes long. For 60 bytes of traffic, in step 230, the conventional approach invalidates 1,514 bytes. This is a significant processing time compared to other packet forwarding steps, where the packet processing operation may only need to process one or two dozens of bytes in the packet header. Similarly, in step 220, the processing time is wasted by invalidating 60 bytes, where only a small number of bytes are modified.

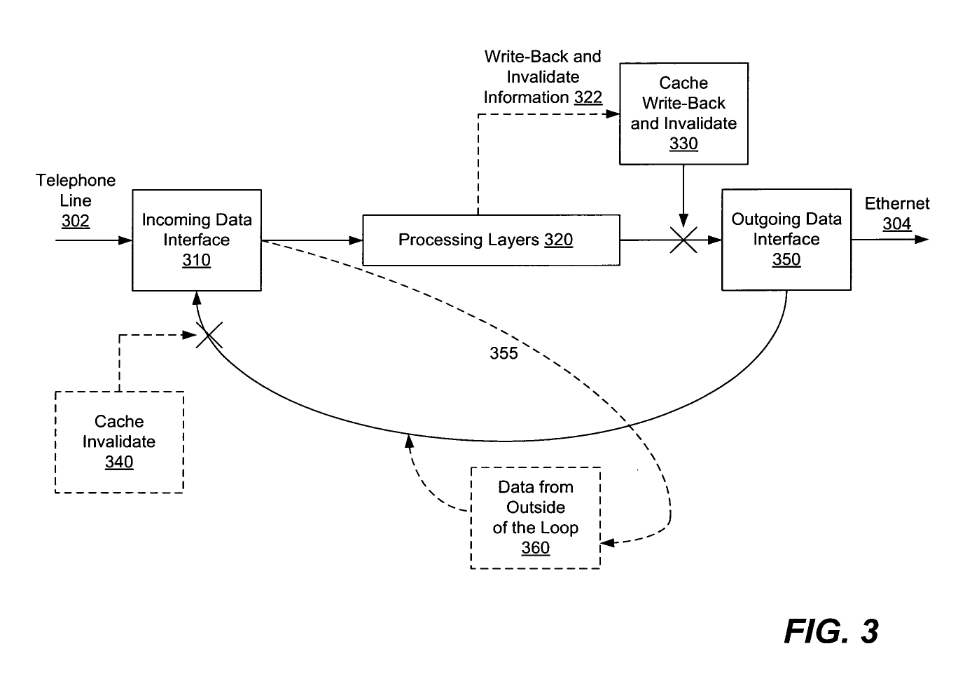

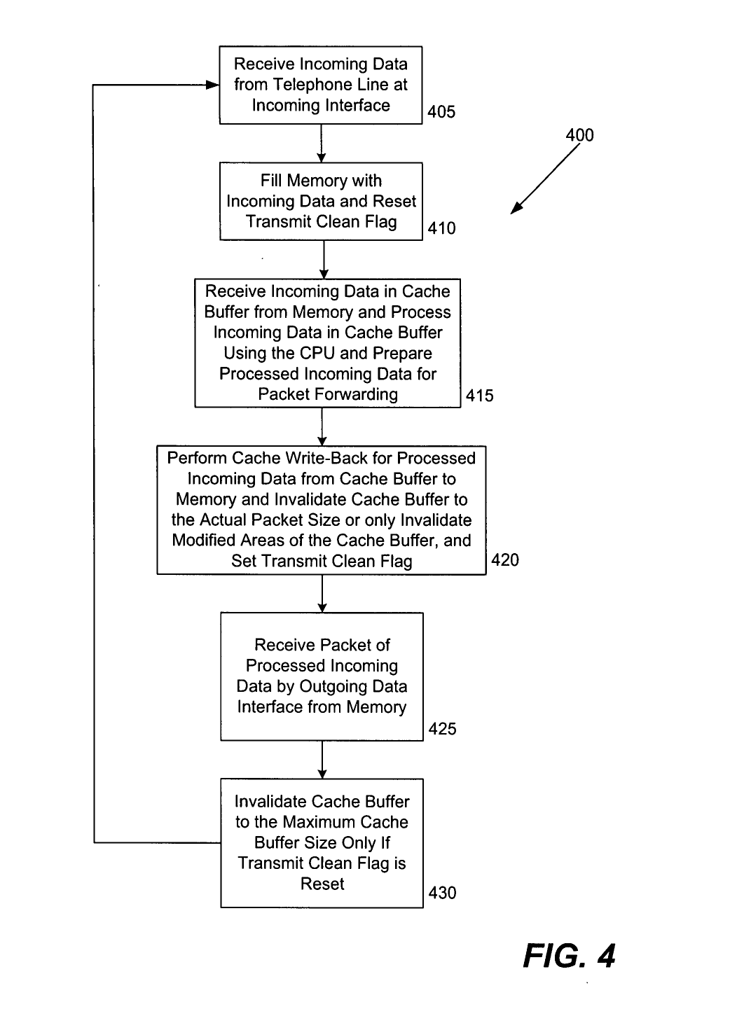

Now, turning to FIG. 3, there is shown data flow diagram 300 for managing cache 140 of FIG. 1 to maintain cache coherency, according to one embodiment of the present invention. FIG. 4 illustrates process flow diagram 400 for managing cache 140 of FIG. 1, which will be described below in conjunction with FIG. 3. As shown, process flow diagram 400 starts at step 405, where incoming data interface 310 (corresponding to incoming data interface 110) receives incoming data over telephone line 302. Next, at step 410, memory 120 receives the incoming data from incoming data interface 310 and is filled with the incoming data. Further, at step 410, CPU 150 (or the cache management firmware (not shown) running on CPU 150) resets a transmit_clean_flag indicative of incoming data arriving into memory 120 for packet forwarding. In one embodiment, incoming data interface 310 and outgoing data interface 330 may use a DMA (Direct Memory Access) to transfer data, without a need for direct communication with CPU 150. Further, in one embodiment, cache 140 may employ a write-back policy.

At step 415, the incoming data from memory 120 is transferred into a cache buffer in cache 140, and CPU 150 applies processing layers 320 to the incoming data in the cache buffer of cache 140 for packetization and to generate processed incoming data or data packets for forwarding over Ethernet connection 304. Further, at step 415, processing layers 320 communicate cache write-back and invalidate information 322, such as range of addresses or buffer indexes to cache write-back and invalidate 330.

Next, at step 420, CPU 150 performs cache write-back and invalidate 330 to write the processed incoming data from the cache buffer of cache 140 into memory 120, and in order to ensure cache coherency, to invalidate the cache buffer of cache 140 to the actual packet size, e.g. an actual packet size from 60 bytes to 1,514 bytes. In one embodiment of the present invention, cache write-back and invalidate 330, however, is only applied to the areas of the cache buffer of cache 140 that have actually been modified or read by processing layers 320. For example, if processing layers 320 only modify 16 bytes or a line of cache, only those 16 bytes are invalidated to save processing time. Further, at step 420, CPU 150 (or the cache management firmware (not shown) running on CPU 150) sets the transmit_clean_flag indicative of cache buffer of cache 140 having been cleaned at step 420. In one embodiment, cache write-back and invalidate may be applied concurrently or using a single instruction. As a result of step 420, the cache buffer(s) or the range of cache addresses that have stored the packet to be forwarded is recycled to free space for receiving new packets. The cache invalidation step 420 is an important step, because of the invalidation is not timely performed, CPU 150 will read stale data rather than a new packet.

At step 425, outgoing data interface 350 receives the processed incoming data, i.e. the data packet generated by CPU 150 and transferred from cache 140 to memory 140, and outgoing data interface 350 forwards the packet over Ethernet connection 304.

Next, at step 430, in order to ensure cache coherency, CPU 150 applies cache invalidate 340 to invalidate the cache buffer in cache 140 to the maximum cache buffer size, e.g. 1,514 bytes, only if the transmit_clean_flag is not set, which is indicative of a dirty transmit buffer that is in need of cleaning. Such situations where CPU 150 needs to invalidate the entire cache buffer in cache 140 arises where incoming data are not received from the main loop starting with telephone line 302 and progressing through processing layers 320 and forwarding packets through outgoing data interface 350, but are received from outside of the loop 360. These situations, for example, occur where rather than forwarding the packet, the packet is dropped or passed up from incoming data interface 310 to a local network stack, shown by dotted line 355, and then received from outside of the loop 360 through dotted line 365. Lastly, process flow diagram 400 returns to step 405 for processing additional incoming data.

Therefore, according to one aspect of the present invention, steps 420 and 430 eliminate the wasteful and unnecessary invalidation of cache 140 for the entire packet size and the entire buffer size, in steps 220 and 230 of the conventional approach, respectively, and provide a more efficient cache management methodology.

From the above description of the invention it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method of managing a cache memory in a communication device including a logic device, a main memory, an incoming data interface and an outgoing data interface, the method comprising:
resetting a flag indicative of lack of incoming data for generating a packet for forwarding;
receiving the incoming data by the incoming data interface;
storing the incoming data in the main memory;
transferring the incoming data from the main memory into a cache buffer within the cache memory, the cache buffer having a buffer size;
setting the flag indicative of the incoming data received for generating the packet for forwarding;
processing the incoming data to generate the packet in the cache buffer for forwarding, the packet having a packet size;
writing back the packet from the cache buffer into the main memory;
first invalidating a portion of the cache buffer;
transmitting the packet by the outgoing data interface after the first invalidating; and
second invalidating, after the transmitting, the cache buffer for the buffer size if the flag is not set by the setting.

2. The method of claim 1, wherein the first invalidating invalidates the portion of the cache buffer modified by the processing the incoming data.

3. The method of claim 1, wherein the first invalidating invalidates the cache buffer for the packet size.

4. The method of claim 1, wherein the writing back and the first invalidating occur concurrently using a single instruction.

5. The method of claim 1, wherein the logic device is a central processing unit.

6. The method of claim 1, wherein the communication device is a DSL (digital subscriber line) modem.

7. The method of claim 1, wherein the incoming data interface is in communication with a telephone line.

8. The method of claim 1, wherein the outgoing data interface is in communication with an Ethernet connection.

9. A communication device for forwarding a packet, the communication device comprising:
a logic device operable to reset a flag indicative of lack of incoming data for generating the packet for forwarding;
an incoming data interface operable to receive the incoming data;
a main memory for storing the incoming data;
a cache memory including a cache buffer, the cache buffer having a buffer size;
an outgoing data interface for forwarding the packet;
the logic device being operable to transfer the incoming data from the main memory into the cache buffer, to set the flag indicative if the incoming data are received for generating the packet for forwarding, and to process the incoming data to generate the packet in the cache buffer for forwarding, the packet having a packet size;
the logic device being operable to write back the packet from the cache buffer into the main memory, and to first invalidate a portion of the cache buffer, prior to the outgoing data interface transmitting the packet;
the logic device being operable to invalidate, after the outgoing data interface transmits the packet, the cache buffer for the buffer size if the flag is not set.

10. The communication device of claim 9, wherein the logic device is operable to first invalidate the portion of the cache buffer modified by the processing the incoming data.

11. The communication device of claim 9, wherein the logic device is operable to first invalidate the cache buffer for the packet size.

12. The communication device of claim 9, wherein the write back and the first invalidation occur concurrently using a single instruction.

13. The communication device of claim 9, wherein the logic device is a central processing unit.

14. The communication device of claim 9, wherein the communication device is a DSL (digital subscriber line) modem.

15. The communication device of claim 9, wherein the incoming data interface is in communication with a telephone line.

16. The communication device of claim 9, wherein the outgoing data interface is in communication with an Ethernet connection.
